(19) United States
(12) Patent Application Publication
(10) Pub. No.: US 2011/0189462 A1
(43) Pub. Date: Aug. 4, 2011

(54) ENCAPSULATED PHOTOCHROMIC DYES

(76) Inventors: XIE Shihui, Singapore (SG); Araz Prihantoro, Singapore (SG); Angelina Octaviani Arykwan, Singapore (SG)

(21) Appl. No.: 12/746,761

(22) PCT Filed: Dec. 7, 2008
(86) PCT No.: PCT/SG08/00461

§ 371 Date: Oct. 12, 2010

Related U.S. Application Data
(60) Provisional application No. 61/005,755, filed on Dec. 7, 2007.

(51) Int. Cl. B32B 3/26; C08K 9/10; C09D 183/06

(52) U.S. Cl. 428/304.4; 523/209; 523/201

(57) ABSTRACT

A photochromic dye encapsulated by a dendritic polymer. The encapsulated photochromic dye having an increased fade rate.

### TECHNICAL FIELD

The present invention generally relates to encapsulated photochromic dyes, to methods associated with their manufacture and to articles coated with the photochromic dyes.

### BACKGROUND

Photochromism is a reversible transformation of a chemical species by absorption of electromagnetic radiation between two forms having different absorption spectra (Pure Appl. Chem., 73, 639, 2001). This reaction gives rise to the formation of photoisomers whose electronic absorption spectra are markedly different from that of the reactant molecule, which results in a dramatic color change. As for organic photochromic molecules, the reactant is generally colorless, meaning that its electronic absorption starts only from the UV region (<350 nm), while the products induced by the UV irradiation show the intense absorption in the visible region (400 to 700 nm). Changes in other molecular properties, such as reflective and dielectric constants can also occur along with the color change during the photochromic reaction.

Photochromism has attracted much attention for the past few years due to the reversible phenomenon in which the photochromic compound exhibits a reversible change in color when exposed to light radiation including ultraviolet rays such as sunlight or light from a mercury lamp. While the forward reaction is always photochemical, the reverse reaction is induced mostly by a thermal mechanism at room temperature. Some photochromic molecules yield thermally stable photoproducts, in such cases back reactions are photochemical. These phenomena have received great attention because photochromic compounds have a wide variety of commercial applications, such as in ophthalmic glasses, optical switches, optical memories, and nonlinear optical devices.

A wide variety of photochromic dyes have been developed in recent years and photochromic dyes as commercial products are becoming more prevalent. These photochromic dyes have been extensively applied to materials including optical lenses. In recent years, photochromic lenses in which photochromic dyes, have been applied are currently being marketed for use in eyeglasses.

The photochromic compounds present in the photochromic dyes return to their original color when it is placed in the dark by discontinuing irradiation. For most photochromic compounds, the general mechanism responsible for the reversible change in color involves an electrocyclic mechanism. When exposed to activating radiation, these compounds transform from a colorless (or colored) closed ring compound into a colored (or colorless) open ring species. The factors that can influence the switching rate of the photochromic compounds are the inherent molecular structure of the photochromic compounds and the surrounding environment that the photochromic compounds are located, including solubility, polarity, rigidity, and temperature, etc.

The switching rate, in particular the time it takes for a darkened lens to fade (fading rate) and vice versa, is an important feature of photochromic lenses in today's market. A problem encountered by potential customers is the length of time it takes for the photochromic lens to fade completely when moved from bright light (e.g. outdoors) to low light (e.g. indoors) conditions. During this fading period, the lenses go through an intermediate transmission range that many wearers find uncomfortable because due the slow fading rate, the lenses are initially too dark and are unattractive.

Accordingly, one of the challenges encountered when incorporating organic photochromic dyes into plastic materials is the difficulty in obtaining a satisfactory photochromic speed from the faded to darkened state and vice versa. In recent years, research has been undertaken to develop photochromic compounds that exhibit a quicker switching rate. One such method involves the direct mixing of the photochromic dyes with a lens monomer, followed by curing of the mixture solution. However, the fading rate of the photochromic lenses is slow and usually takes more than ten minutes to switch from a darkened to a colorless state.

Another method involves adding photochromic dyes into the hard coating materials to manufacture photochromic lenses. Similarly, such lenses exhibited a slow fading rate and an uneven dispersion of the dyes within the coating layer.

Other known methods include dissolving the photochromic compound in a polymerizable monomer composition. These photochromic compounds are cured and casted onto the surface of the lenses to obtain enhanced photochromic properties. However, a disadvantage in such coating methods is the difficulty in achieving a satisfactory adhesion between the lens and the photochromic coating layer. Furthermore, the fading rate is still too slow.

In addition to the slow rate of darkening and fading of photochromic compounds in polymers, a common problem in the widespread commercial use of photochromic compounds in combination with plastic materials is the loss of their ability to exhibit a reversible change in color as a result of prolonged repeated exposure to ultraviolet (UV) light.

There remains a need to develop techniques for increasing the switching rate of photochromic compounds especially in the manufacture of photochromic lenses.

### SUMMARY

According to a first aspect, there is provided a photochromic dye encapsulated by a dendritic polymer.

Advantageously, the encapsulated photochromic dye has an increased fade rate relative to photochromic dyes encapsulated in non-dendritic polymers, such as straight chain polyolefins. However, in some embodiments, the encapsulated photochromic dye may then be dispersed or encapsulated in a non-dendritic polymer

According to a second aspect, there is provided an article comprising a photochromic dye encapsulated by a dendritic polymer.

According to a third aspect, there is provided an optical lens, such as an ophthalmic lens, comprising a photochromic dye encapsulated by a dendritic polymer.

According to a fourth aspect, there is provided a method of encapsulating photochromic dye comprising the step of mixing a photochromic dye solution with a dendritic polymer solution.

### DEFINITIONS

The following words and terms used herein shall have the meaning indicated:

The term “dendritic polymer” refers to a polymer species, which includes generally defined dendrimers and hyperbranched polymers. The dendrimer typically has a regularly repeated branching structure, while the hyperbranched polymer typically has an irregularly repeated branching structure. These polymers may have a structure in which the polymer chains are dendritically branched from one focal point, or a structure in which polymer chains are radiated from a plurality of focal points linked to a polyfunctional molecule serving as a core. The dendritic polymers disclosed herein encompass dendritic polymers having a regularly repeated branching structure and those having an irregularly repeated branching structure, wherein these two types of dendritic polymers may have a dendritically branching structure or a radially branching structure. When a dendritic structural unit extends from its preceding dendritic structural unit as an exact copy thereof, the extension of the unit is referred to as the subsequent “generation”. The concepts in relation to dendritic polymer, dendrimer, hyperbranched polymer, etc. are described in, for example, Masaaki KAKIMOTO, Chemistry, Vol. 50, p. 608 (1995) and Kobunshi (High Polymers, Japan), Vol. 47, p. 804 (1998), and these publications can be referred to and are incorporated herein by reference. However, the descriptions in these publications are incorporated for reference Only and are not be construed as limiting the present invention to the dendritic polymers disclosed therein.

The term “non-dendritic polymer” and grammatical variations thereof refer to substances that are either homopolymers, which are formed from monomeric units of a single type, or copolymers, which are formed from two or more different types of monomeric units, which are typically straight chain, does which not have a dendritic macrostructure.

The terms “non-polar” and “hydrophobic” are to be used interchangably and are to be understood to mean a polymer, or part of a polymer, or a mixture of polymers, that exhibit a low intermolecular attraction for aqueous solvents such as water. Alternatively, the terms “polar” and “hydrophilic” are to be used interchangably and are to be understood to mean a polymer, or part of a polymer, or a mixture of polymers, that exhibit a high intermolecular attraction for aqueous solvents such as water.

The term “silane” and grammatical variations thereof refers to silicon-containing compounds containing at least one silicon atom bonded to at least one hydrogen atom or bonded to at least one carbon atom.

The terms “cure”, “cured” and grammatical variations thereof, when used to refer to a cured or curable composition, is intended to mean that at least a portion of the polymerizable and/or crosslinkable components that form the curable composition are at least partially polymerized and/or crosslinked. Hence, once cross-linked, the terms includes polymerized compositions that have been completely polymerized (ie about 100%) and those that have been only partially polymerized (ie about 5%).

The terms “photochromic coating”, “photochromic coat” and grammatical variations thereof, refer to a coating on the surface of an article. The photochromic coating may completely cover the surface of the article or may only partly cover the article.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DETAILED DISCLOSURE OF EMBODIMENTS

### Encapsulated Photochromic Dyes

Exemplary, non-limiting embodiments of a photochromic dye encapsulated by a dendritic polymer, will now be disclosed.

In embodiments disclosed herein, the bleach rate of the encapsulated photochromic dye, as reported in terms of the fading half-life (T_{1/2}) according to SUNGLASS STANDARD REVISION—EN 1836, is typically not more than 100 seconds, more typically not more than 80 seconds, more typically not more than 60 seconds, more typically not more than 50 seconds, more typically not more than 30 seconds.

The half-life fade rate is the time interval in seconds for the change in optical density (Δ_{OD}) of the encapsulated dye photochromic to reach one half the highest Δ_{OD} after removal of the source of activating light. The aforedescribed values for change in optical density and bleach rate are measured at 22° C.

As is known in the art, photochromic compounds of which dye is comprised switch between different conformations upon exposure to ultra-violet light. Without being bound by theory, it is speculated that because the compounds of which the dyes are comprised reside within voids of the dendritic polymer, the compounds are not hindered, or at least have reduced hindrance relative to dyes residing in a straight chain polymeric matrix, as they switch between the different conformation states.

The encapsulated dye may be provided in a substrate. The substrate may be a non-dendritic polymer, such as a transparent plastic substrate. The transparent plastic substrate may be selected from the group consisting of acrylic-based polymers and copolymers, polymethylmethacrylate, polycarbonate, polyolallyl-carbonates, polyesters, polyethylenes, cellulose esters, polyacrylates, polystyrene, polyurethanes polyethersulfones, olefin-maleimide copolymers and combinations thereof.

Once the encapsulated dye has been formed, it may be dispersed in a polymerizable composition of which the substrate may be formed. Exemplary polymerizable compositions are disclosed in U.S. Pat. No. 7,261,843 which is incorporated herein in its entirety for reference.

The amount of encapsulated dye in provided in said substrate may be in the range of about 0.1% (wt) to about 20% wt.

### The Photochromic Dye

In one embodiment, the photochromic dye may comprise hydrophobic groups. Exemplary hydrophobic groups include alkyls, alkenyls, large chain alkoxys, large chain alkylacyls and large chain alkylaminos, wherein said large chains have at least 5 carbon atoms.

The photochromic dye may comprise compounds selected from the group consisting of aminotriarylmethanes, aminoxanthenes, anthraquinones, azobenzene, benzopyran, chromenes, dihydropyrene, indeno-naphthopyrans, phenanthropyrans, phthalocyanines, spiro-oxazines, spiropyrans, spirothiopyrans, chromenes, naphthopyrans, oxazines, organo-metal dithiozonates, pyrans, thioindigo, triphenylmethanes, fulgides, fulgimides and combinations thereof.

Exemplary spiropyrans include spiro(benzindoline)naphthopyrans, spiro(indoline)benzopyrans, spiro(indoline)naphthopyrans, spiro(indoline)quinopyrans and spiro(indoline)pyrans. Exemplary oxazines include spiro(indoline)naphthoxazines, spiro(indoline)pyridobenzoxazines, spiro(benzindoline)pyridobenzoxazines, spiro(benzindoline)naphthoxazines and spiro(indoline)benzoxazines. An exemplary organo-metal dithiozonates include mercury dithizonates such as those disclosed in U.S. Pat. No. 3,361,706. Exemplary indeno-naphthopyrans are those as disclosed in U.S. Pat. No. 5,645,767 at column 1, line 10 to column 12, line 57, and U.S. Pat. No. 5,658,501 at column 1, line 64 to column 13, line 36.

Further exemplary photochromic compounds and complementary photochromic compounds are described in U.S. Pat. No. 5,166,345 at column 3, lines 36 to column 14, line 3; U.S. Pat. No. 5,236,958 at column 1, line 45 to column 6, line 65; U.S. Pat. No. 5,252,742 at column 1, line 45 to column 6, line 65; U.S. Pat. No. 5,359,085 at column 5, line 25 to column 19, line 55; U.S. Pat. No. 5,488,119 at column 1, line 29 to column 7, line 65; U.S. Pat. No. 5,821,287 at column 3, line 5 to column 11, line 39; U.S. Pat. No. 6,113,814 at column 2, line 23 to column 23, line 29; U.S. Pat. No. 6,153,126 at column 2, line 18 to column 8, line 60; U.S. Pat. No. 6,296,785 at column 2 line 47 to column 31, line 5; U.S. Pat. No. 6,348,604 at column 3, line 26 to column 17, line 15; U.S. Pat. No. 6,353,102 at column 1, line 62 to column 11, line 64; U.S. Pat. No. 5,645,767, and U.S. Pat. No. 5,658,501.

Spiro(indoline)pyrans are also described in the text, Techniques in Chemistry, Volume III, “Photochromism”, Chapter 3, Glenn H. Brown, Editor, John Wiley and Sons, Inc., New York, 1971.

The encapsulated photochromic dye can contain one photochromic compound or a mixture of two or more photochromic compounds, as desired. Mixtures of photochromic compounds can be used to attain certain activated colors such as a near neutral gray or near neutral brown. See, for example, U.S. Pat. No. 5,645,767, column 12, line 66 to column 13, line 19, which describes the parameters that define neutral gray and brown colors.

### Dendritic Polymer

The dendritic polymer may be selected such that it is miscible with a substrate. The substrate may be a polymer formed from resin. Hence, during the manufacture process, the resin of the substrate may be mixed with the encapsulated photochromic dye before any curing step. The miscibility of the resin of the substrate and the encapsulated dye allows the dye to be suspended in the solid plastic substrate upon curing. The dendritic polymer may be selected such that it is immiscible with a solvent containing said photochromic dye. In one embodiment, the solvent dissolves the dendritic polymer, but not the dye. In another embodiment, the one of the two immiscible solvents is used to dissolve the dye while the other is used to dissolve the dendritic polymer. This allows the photochromic dye to be encapsulated by the dendritic polymer.

In one embodiment, the photochromic dye is in a polar solvent while at least part of the dendritic polymer is also polar to allow miscibility therebetween.

In one embodiment, it is the terminal ends of said dendritic polymer that are miscible with said substrate. The dendritic polymer may be chosen so that its terminal ends are miscible with the substrate. The inner core of said dendritic polymer may be of substantially the same polarity as said photochromic dye.

In one embodiment, the terminal ends of the dendritic polymer may be polar relative to its inner core. In one embodiment, the inner core of the dendritic polymer is hydrophobic. During the process of forming the encapsulated dye, the photochromic dye may be dissolved in a polar solvent to form a polar photochromic dye solution. The polar photochromic dye solution may then be mixed with the dendritic polymer. The polar terminal ends of the dendritic polymer allow it to be miscible with the polar photochromic dye solution. A phase transfer can then occur as the photochromic dye, being relatively non-polar, is encapsulated within the inner core of the dendritic polymer.

The dendritic polymer may be a dendrimer or a hyperbranched polymer.

In one embodiment, the dendritic polymer is of at least 1 generation or about 2 generation to about 7 generations.

In one embodiment, the dendritic polymer is substantially transparent. This is particularly useful in applications wherein the encapsulated polychromic dye is being used in an ophthalmic lens.

In one embodiment, the dendritic polymer is a dendrimer having a substantially hydrophobic inner core. In one embodiment, the inner core of said dendrimer comprises one or more silicon hydrides.

In one embodiment, the outer arms of the dendritic polymer comprise silicon hydride. The silicon hydride may be silane. The silane may be selected from the group consisting of silicon hydrides, arylalkoxy silanes, alkylalkoxy silanes, and mixtures thereof. Exemplary silanes include SiH, SiH₄, SiH₃(CH₃) and SiH₃(CF₃).

In one embodiment, dendritic polymer has a silane or carbosilane inner core. The outer arms radiating from the silane or carbosilane core may comprise other hydrophobic polymers such as polyether, polysulfide, polyester and copolymers thereof. Suitable polyether monomers include alkylene oxide and alkylene glycol in which the alkylene has 2 to 4 carbon atoms. Suitable polysulfide monomers include alkylene sulfide, and alkylene dithioland. Suitable polyesters include glycolic acid lactone (glycolide), lactic acid lactone occurring in L-, D-, DL-forms and racemic mixtures (lactide) and -caprolactone.

In one embodiment, the dendritic polymer is a dendrimer having a first, second or third or fourth generation dendrimer. The dendrimer may be a dendrimer of the first generation with an average diameter of at least 10.8 Angstroms or with an average diameter of at least 22 Angstroms. The arms of said dendrimer may comprise terminal end groups that are substantially hydrophilic. Furthermore, the terminals ends of said hyperbranched polymer may also be substantially hydrophilic. Exemplary hydrophilic groups that may be provided on the terminal groups include a hydroxyl group, a carboxyl group, an ether group, a sulfide group, an ester group, an ethoxy group; a phosphonyl group, a phosphinyl group, a sulfonyl group, a sulfinyl group, a sulfonic acid group, a sulfinic acid group, a phosphoric acid group, a phosphorous acid group, an amino group, an amide group, a quaternary ammonium group, and a quaternary phosphonium group. Hence, in one embodiment, the terminal ends of said dendritic polymer are hydroxyl groups. Suitable dendrimers that may be contemplated for use include silicon containing star dendrimers such as those disclosed in U.S. Pat. No. 6,350,384 and dendrimers having a hydrophobic core with a hydrophilic terminal groups such as those disclosed in U.S. Pat. No. 6,730,334, U.S. Pat. No. 7,265,186.

Where the dendritic polymer is a hyperbranched polymer, it may also have hydrophillic end groups, which may also be selected from the group consisting of a hydroxyl group, a carboxyl group, an ether group, a sulfide group, an ester group, an ethoxy group, a phosphonyl group, a phosphinyl group, a sulfonyl group, a sulfinyl group, a sulfonic acid group, a sulfinic acid group, a phosphoric acid group, a phosphorous acid group, an amino group, an amide group, a quaternary ammonium group, and a quaternary phosphonium group.

Suitable hyperbranched polymers that may be contemplated for use and which have a hydrophobic inner core include U.S. Pat. No. 6,328,988, U.S. Pat. No. 6,497,895 and U.S. Pat. No. 6,328,988. In one embodiment, the hyperbranched polymer may be hyperbranched polysiloxane such as polysiloxysilane.

Hyperbranched polysiloxysilanes may be synthesized as shown in schema 1:

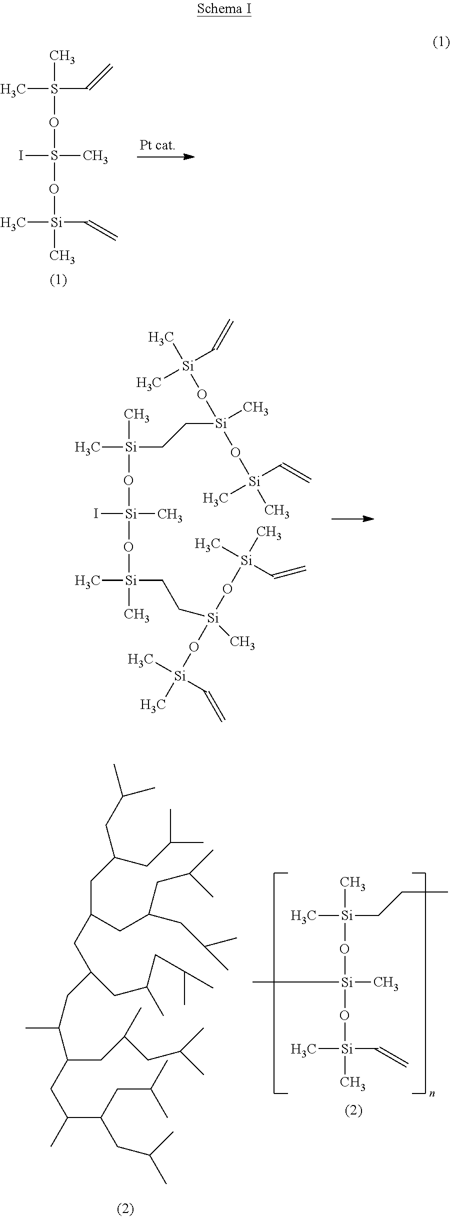

Alternatively, hyperbranched polysiloxysilanes may be synthesized as shown in schema II:

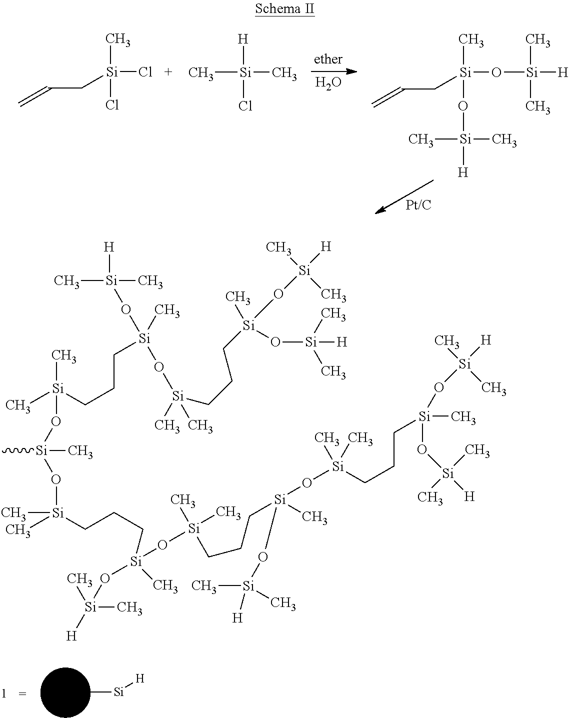

An advantage of using hyperbranched polysiloxysilanes is that they have a strong affinity to organic polymers which may be used in ophthalmic lenses, such as polycarbonate lenses. Hence, they are particularly useful for applications in which the encapsulated photochromic dye will be used in an ophthalmic lens.

Where these hyperbranched polymers do not have hydrophilic terminal end groups, the polymers may be modified so that such hydrophilic groups may be grafted thereon. The terminal hydrophilic groups of the dendritic polymer may be formed by modifying the dendritic polymer. For example, hydroxyl-terminated dendritic polymers can be prepared from either radical polymerization of a dendritic polymer having alkenyl terminal groups in the presence of hydrogen peroxide or anionic polymerization of the dendritic polymer having alkenyl terminal groups, followed by termination with alkylene oxides. Alternatively, the dendritic polymer may be terminated with acids such as hydrochloric acid or acetic acid, resulting in an hydroxyl terminal group thereon. Alternatively, hydroxyl terminal groups may be formed on the dendritic polymers by reacting said dendritic polymers with curable end group modifiers such as allyl glycidyl ether, in the presence of an alkali catalyst, followed by addition of ether modifier to a predetermined epoxy:ether molar ratio.

In one embodiment, the fade rate of the photochromic dye may be dependent on the amount of epoxy modifier introduced to modify the end groups of the dendritic polymers. Generally, the higher the amount of epoxy modifier introduced, the slower will be the fade rate. However, the fade rate of photochromic dye encapsulated will still be relatively faster compared to a non-encapsulated system.

In another embodiment, the activation level of the encapsulated photochromic dye may be dependent on the amount of ether modifier introduced to a mixture of dendritic polymer, epoxy modifier and alkali catalyst. Advantageously, the higher the amount of ether modifier introduced, the lower % of transmission in an article fitted with said photochromic dye.

Advantageously, molar ratio of epoxy:ether modifier used to modify the dendritic polymer may be adjusted to obtain optimal fade rate and % transmission required for an article fitted with said photochromic dye.

In one embodiment, the dendritic polymer is modified using a ratio of epoxy:ether of typically 7:3, more typically 4.2:6, more typically 4.2:4, more typically 3.4:7.4, more typically 3:8, more typically 3:7.4, more typically 3:7, more typically 3:6 and more typically 2.4:7.

In other embodiments, hydroxyl functional groups may be incorporated into the terminal ends of the dendritic polymer by using functional monomers, such as hydroxyalkyl acrylates and methacrylates, having 2 to 4 carbon atoms in the hydroxyalkyl group. Non-limiting examples of such materials including hydroxyethyl acrylate, hydroxyethyl methacrylate, hydroxypropyl acrylate, hydroxypropyl methacrylate, 4-hydroxybutyl acrylate, 4-hydroxybutyl methacrylate and the like. Also hydroxy functional adducts of caprolactone and hydroxyalkyl acrylates and methacrylates can be used. Mixtures of these hydroxyalkyl functional monomers can also be used.

There may be provided an ophthalmic lens comprising the encapsulated photochromic dye. The encapsulated photochromic dye may be provided in a coating layer disposed on said lens. The encapsulated photochromic dye may be provided within said ophthalmic lens.

There may be provided photochromic articles comprising said encapsulated dye. The photochromic articles can contain one of said encapsulated photochromic compounds or a mixture of said encapsulated photochromic compounds, as desired. Mixtures of said encapsulated photochromic compounds can be used to attain certain activated colors such as a near neutral gray or brown or a fashionable color such as pink. Further discussion of neutral colors and ways to describe colors can be found in U.S. Pat. No. 5,645,767, column 12, line 66 to column 13, line 19.

In one embodiment, the photochromic article is an optical film.

In another, the photochromic article may be a security identifier. That is, the encapsulated dye could be used on an identification device that would form an indicia on exposure to ultraviolet light.

In another, the photochromic article may be a packaging comprising said encapsulated dye. The encapsulated dye may form an indicia on exposure to ultraviolet light.

### Encapsulation of the Photochromic Dye

There may be provided a method of encapsulating photochromic dye comprising the step of mixing a photochromic dye solution with a dendritic polymer solution.

In one embodiment, the method comprises the steps of dissolving the modified dendritic polymer with a suitable organic solvent, followed by incorporation of photochromic dye that is partially soluble in said organic solvent, such as methanol, and mixing of this mixture at elevated temperature to induce the transfer of photochromic dye from solvent medium into the dendritic polymer's cavities.

In another embodiment, the method comprises the step of dissolving the dendritic polymer in an alcohol based solvent such as methanol, ethanol, propanol, butanol and mixtures thereof or a halogenated organic solvent such as fluorinated organic solvent

In another, the method comprises the step of selecting a dendritic polymer to be miscible with the solvent of photochromic dye solution.

In another, the method comprises the step of modifying the terminal ends of a dendritic polymer to be miscible with the solvent of photochromic dye solution.

In yet another embodiment, the method comprises the step of curing a polymerizable composition comprising the encapsulated photochromic dye.

### Photochromic Coatings

Photochromic coatings containing the encapsulated photochromic dye can be applied to various articles such as ophthalmic lenses. The photochromic coating can be used in applications where it is desirable to have the coating change color or transparency upon exposure to ultraviolet light. In one application, the coating may be provided on a glass substrate so that the glass turns darker upon exposure to ultraviolet light but becomes more transparent when not exposed to ultraviolet light. Such applications may be useful in windows of building and vehicle windows. Typically the photochromic coatings comprise the encapsulated photochromic dye suspended in a non-dendritic polymer matrix.

After the photochromic dye has been encapsulated by the dendritic polymer, it may be incorporated into a polymer-forming coating composition by various methods described in the art so that the encapsulated photochromic dye is suspended in the non-dendritic polymer matrix. Such methods include adding the encapsulated photochromic dye to one or more of the materials used to form the polymer coating. In such methods, the encapsulated photochromic dyes can be dissolved and/or dispersed in an aqueous or organic solvent prior to being incorporated into one or more of the components of the polymer coating composition.

In one embodiment, the encapsulated photochromic dye, comprising the dye and dendritic polymer can be cured to form a coating layer, without a need of incorporating said encapsulated photochromic dye into a polymer-forming coating composition.

Alternatively, the encapsulated photochromic dye can be incorporated into a cured non-dendritic polymer matrix by imbibition, permeation or other transfer methods as known by those skilled in the art. Non-dendritic polymers that may used in the non-dendritic polymer matrix are compositions adapted to provide thermoplastic or thermosetting Coatings that are described in the Kirk-Othmer Encyclopedia of Chemical Technology, Fourth Edition, Volume 6, pages 669 to 760. The coatings may be transparent, translucent or opaque. Exemplary compositions for forming the non-dendritic polymer matrix upon curing include those selected from polyurethanes, aminoplast resins, silanes, poly(meth)acrylates, such as polyacrylates and polymethacrylates, polyanhydrides, polyacrylamides, and epoxy resins.

In one embodiment, the non-dendritic polymer matrix comprises a polyurethane. The polyurethane coatings that can be used may include those that can be produced by the catalyzed or uncatalyzed reaction of an organic polyol component and an isocyanate component in the presence of photochromic compound(s). Materials and methods for the preparation of polyurethanes are described in Ullmann's Encyclopedia of Industrial Chemistry, Fifth Edition, 1992, Vol. A21, pages 665 to 716. Examples of organic polyols, isocyanates and other components that can be used to prepare the polyurethane coating are disclosed in U.S. Pat. Nos. 4,889,413 and 6,187,444B1.

The non-dendritic polymer matrix (or precursor formulation) can contain additional conventional adjuvants that impart desired properties or characteristics to the polymer coating, that are required by the process used to apply and cure the encapsulated photochromic dye on the surface of the plastic substrate, or that enhance the performance of the coating. Such adjuvants include, but are not limited to, ultraviolet light absorbers, light stabilizers, such as hindered amine light stabilizers (HALS), asymmetric diaryloxalamide (oxanilide) compounds, and singlet oxygen quenchers, e.g., a nickel ion complex with an organic ligand, antioxidants, polyphenolic antioxidants, heat stabilizers, rheology control agents, leveling agents, e.g., surfactants, free radical scavengers and adhesion promoting agents, such as trialkoxy silanes, e.g., silanes having an alkoxy radical of 1 to 4 carbon atoms, including γ-glycidoxypropyl trimethoxy silane, γ-aminopropyl trimethoxysilane, 3,4-epoxy cyclohexylethyl trimethoxysilane, dimethyldiethoxysilane, aminoethyl trimethoxysilane, and 3-(trimethoxysilyl)propyl methacrylate.

The amount of the encapsulated photochromic dye used in the photochromic coatings is in an amount sufficient to produce a photochromic effect discernible to the naked eye upon activation. Generally such amount can be described as a photochromic amount. The encapsulated photochromic dye are used in photochromic amounts and in a ratio (when mixtures are used) such that a coating composition to which the compound(s) is applied or in which it is incorporated exhibits a desired resultant color when activated with unfiltered sunlight. In a non-limiting embodiment, the encapsulated photochromic dye relative to the weight of the polymeric film in which the encapsulated photochromic dye is provided, is in an amount selected from the ranges consisting of about 0.1 to about 40 weight percent, about 0.5 to about 30 weight percent, about 1 to about 20 weight percent, about 2 to about 15 weight percent and about 3 to about 14 weight percent.

The photochromic coating composition can be provided on a substrate. In one embodiment, the cured coating can have a thickness of from about 1 to 10,000 microns, or from about 5 to 1,000 microns, or from about 10 to about 400. The polymer-forming coating composition can be applied by any of the methods used in coating technology such as, for example, spray coating, spin coating, spread coating, curtain coating, dip coating, casting or roll-coating.

Following application of the coating composition to the substrate, the coating is generally cured, at least partially. The temperature used to at least partially cure the coating can vary widely depending on the components selected for the coating composition of the present invention. In one contemplated embodiment, the coating can be cured at temperatures ranging from about 22° C. to about 150° C. If heating is required to obtain a cured coating, temperatures of between 80° C. to 140° C. can be used. While a range of temperatures has been described for curing the coated substrate, it will be recognized by persons skilled in the art that temperatures other than those disclosed herein can be used. Additional methods for curing the photochromic coating composition include irradiating the coating with infrared, ultraviolet, visible, microwave, or electron radiation. This may be followed by a heating step.

In one embodiment, the photochromic coating is applied to a plastic polymer substrate. Prior to applying the photochromic coating to the surface of the polymer substrate, the surface of the substrate is often cleaned and treated to provide a clean surface and a surface that will enhance adhesion of the photochromic coating to the substrate. Exemplary treatments may include ultrasonic washing with an aqueous soap or detergent solution.

It is desirable that the resulting cured photochromic coating containing the encapsulated photochromic dye is devoid of cosmetic defects such as pits, spots, inclusions, cracks and crazing of the coating. In one embodiment, the polymeric coating containing the encapsulated photochromic dye is substantially free of cosmetic defects such that any defects present do not detract from the aesthetic appearance of the article.

The photochromic coating may be used to coat various articles. For example, the photochromic coating could be used to coat optical lenses such as ophthalmic and plano lenses and camera lenses. The photochromic coating could also be used to coat other articles such as face shields, goggles, ski goggles, visors, windows, automotive windshields, aircraft and automotive transparencies such as T-roofs, sidelights and backlights, plastic films and sheets. The photochromic coating could be used as in “textiles coatings” such as paints, and verification marks on security documents such as banknotes, passports and drivers licenses for which authentication or verification of authenticity may be desired.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 is a graph showing kinetic data of a lens fitted with encapsulated dendritic polymer modified with different amounts of epoxy modifier.

FIG. 2 is a graph showing kinetic (or Transmittance) data of lens fitted with encapsulated dendritic polymer modified with different amounts of ether modifier.

### EXAMPLES

Non-limiting examples of the invention, including the best mode, and a comparative example will be further described in greater detail by reference to specific Examples, which should not be construed as in any way limiting the scope of the invention.

### Example 1

### Synthesis of a Modified Hyperbranched Polymer Liquid

A transparent free-flowing modified hyperbranched polymer liquid is prepared in this example according to the process disclosed below.

A mixture of pure hyperbranched polysiloxysilane (8 g) and platinum on carbon catalyst (Pt/C, 10%) (16 mg) was added to a solution of allyl glycidyl ether (epoxy modifier) (3.3 ml) via a syringe in a round bottom-flask equipped with a magnetic stirrer under an inert atmosphere of argon

The resulting solution was stirred at room temperature (r.t.) for 0.5 h, and was subsequently stirred overnight at 60° C. The reaction mixture was cooled to room temperature (r.t.) and ether modifier (2.7 ml) was slowly added via a syringe. (Molar ratio of epoxy to allyl ether used here is 7:3) The reaction mixture was stirred for 8 h at 50° C. Once the reaction finished, the mixture was cooled to r.t. Dichloromethane (excess) was added into the reaction mixture to selectively dissolve the modified hyperbranched polymer before the reaction mixture was filtered into another round bottom flask to remove the Pt/C.

The resulting mixture was transferred into a Rotavapor to allow the evaporation of the dichloromethane solvent at room temperature (r.t.) for 1 h.

The resulting compound was later dried under a high vacuum at 60° C. for 6 h to remove the excess ether modifier and form the transparent free-flowing modified pure modified hyperbranched polymer liquid (about 12 g)

### Example 2

9.45 g of the modified hyperbranched polysiloxysilane, solution made in Example 1 was dissolved in 37.8 ml of mixed 90 wt % Tert-Butanol and 10 wt % iso-Butanol was mixed with 0.378 g Midnight Grey Reversacol™ (1,2-b-naphthopyrans) commercially available from James Robinson Ltd of Huddersfield, West Yorkshire, United Kingdom. The mixture was then stirred for 3 hours at 70° C., resulting in a clear solution. Afterwards, an amino resin based cross-linker in the range of 2 wt % to 4 wt % was added in order to achieve a hard and fully cured film.

### Example 3

Photochromicity testing of the compositions prepared in Example 2 was conducted. A layer of the monomeric compositions prepared in Example 2 was placed on a polycarbonate ophthalmic lens, which was subsequently subjected to thermal-curing. The polymer layer containing the encapsulated Midnight Grey Reversacol™ dye was 7 μm thick. The amount of Midnight Grey Reversacol™ dye was 3.2 wt % and the amount of polymerized hyperbranched polysiloxysilane was 96.8 wt %. (hereafter “dendritic encapsulated lens”).

A lens fitted having 60 ppm Midnight Grey Reversacol™ dye encapsulated therein obtained from James Robinson Ltd of Huddersfield, West Yorkshire, United Kingdom was also subjected to photochromicity testing (hereafter “non-dendritic encapsulated lens”)

The dendritic and non-dendritic encapsulated lenses were tested for photochromic response rates on an optical bench under SUNGLASS STANDARD REVISION—EN 1836 using an AM2 filter, the conditions of which were 50K Lux light at 23° C. The test parameters were as follows:
Data Type: Transmission
Test Parameters: Transmission scan run following 600 second activation. Lambda max identified on both unactivated and activated transmission scan.
   Activation rate readings taken every 1 second at 590 nm, for 1200 seconds.
   Fade rate readings taken every 1 second at 590 nm, for 2400 seconds.
Reference Used: Blank water bath
Data Collection: The data was exported into excel and provided along with the report

The following test values were obtained and are tabulated in Tables 1 and 2.

TABLE 1
Transmission data

| | | | |
|---|---|---|---|
| | Unactivated | Activated | Change in |
| Wavelength | Transmission | Transmission | Transmission |
| (nm) | (%) | (%) | (%) |

Dendritic Encapsulated

| | | | |
|---|---|---|---|
| 505 | 84.85 | 44.44 | 40.41 |
| 585 | 86.04 | 43.54 | 42.5 |

Non-Dendritic Encapsulated

| | | | |
|---|---|---|---|
| 505 | 88.11 | 41.15 | 46.96 |
| 590 | 90.2 | 39.2 | 51 |

Table 1 shows the transmission data of the encapsulated dendritic polymer vs encapsulated non-dendritic polymer. It can be seen from the data of Table 1 that the transmission of light of the dendritric encapsulated dye is comparable to the non-dendritic embodiment. Hence, encapsulation of a photochromic dye in a lens does not adversely affect the transmittance properties.

TABLE 2
Kinetic Data

| | | | | |
|---|---|---|---|---|
| Start | Finish | T¼ | T½ | T¾ |
| (s) | (s) | (s) | (s) | (s) |

Dendritic Encapsulated

| | | | | | |
|---|---|---|---|---|---|
| Trans | 45.7 | 84.8 | 55.475 | 65.25 | 75.025 |
| Time | | | 9.28 | 26.9 | 57.6 |

Non-Dendritic Encapsulated

| | | | | | |
|---|---|---|---|---|---|
| Trans | 38.88 | 92.55 | 52.298 | 65.715 | 79.133 |
| Time | | | 36.2 | 124 | 687 |

Table 2 shows the kinetic data of the encapsulated dendritic polymer vs. encapsulated non-dendritic polymer. It can clearly be seen from Table 2 that the dendritically encapsulated dye had a significantly faster fade rate compared to the non-dendritically encapsulated dye. In particular, the T_{1/2} half fade rate was almost double for the encapsulated dye compared to the non-dendritically encapsulated dye. Furthermore, the T_{3/4} fade rate was almost 12 fold faster for the encapsulated dye compared to the non-dendritically encapsulated dye, indicating that the overall rate for returning to full clarity is much faster for the encapsulated dye.

### Example 4

In addition to the kinetic data presented in Example 3, the change in Kinetic Data by varying the Epoxy and/or Ether end-group modifier was investigated. The kinetic Fading Data was obtained using Luminous Transmittance meter model STS-2 from Fujikoden Corp, Japan. Prior to Transmittance measurement, the dendritic encapsulated lens was directly exposed to UV light bulb for 1 minute, at Temperature of 23±20 and monitored for 300 s until it reached their clear (non-activated) state.

All lenses being tested were able to go back to their clear state within 5 minutes-time. The photochromic layer was 7-8 μm thick and the amount of Midnight Grey Reversacol™ dye was 3.2 wt % and the amount of polymerized hyperbranched polysiloxysilane was 96.8 wt %.

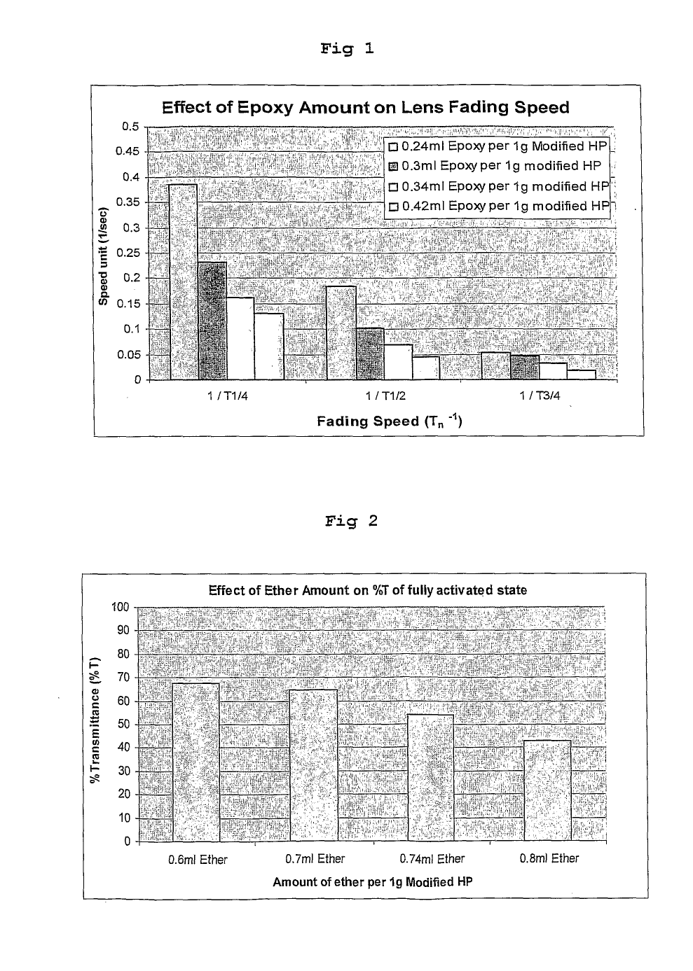

When coating application method is concerned, there needed an optimization work in the modification of dendritic polymer's end groups; one option being the modification using Epoxy and Ether modifier. Further analysis on the effect of each modifier's amount towards Lens' Kinetic performance was presented in the following two graphs, FIG. 1 and FIG. 2.

Epoxy end-group modifier was introduced to enhance the adhesion of encapsulated-dendritic polymer on top of the substrate. Thus, the encapsulated-dendritic polymer can perform as a coating layer. To achieve its optimal function, the amount of epoxy modifier can be varied accordingly. Our researches have investigated the effect of Epoxy amount towards the lens fading kinetic.

As shown in FIG. 1, the fading speed decreases as more Epoxy modifier is attached to dendritic polymer. These T1/4, T1/2 and T3/4 refers to the time required to fade off 25%, 50% and 75% of the total % Transmittance range. Therefore, it is will be appreciated that the right amount of epoxy should be added to promote the film formation without affecting the kinetic property of dyes encapsulated in dendritic polymer.

Other than epoxy end group modification, ether modifier may also be added to help the encapsulation process of the dyes into dendritic hyperbranch by expanding the network in the suitable solvent. Hence, when more ether was incorporated, it will improve the accessibility of dendritic's voids and optimizes the encapsulation process. As depicted in the FIG. 2, an increasing amount of ether per 1 g modified HP will result in lenses having lower % T and darker appearance at its fully activated state.

Conclusively, the addition of appropriate end group modifiers such as epoxy, ether and other suitable terminating units, will help to bring out the optimal function of dendritic polymer as a media to encapsulate the photochromic dye without hindering its switching.

### APPLICATIONS

Advantageously, the disclosed encapsulated photochromic dye has an increased fade rate relative to prior art photochromic dyes, particularly those encapsulated in non-dendritic polymers. Hence, it may be advantageous to use the disclosed encapsulated photochromic dye in a wide variety of applications such as in optical lenses like ophthalmic glasses, optical switches, optical memories, and nonlinear optical devices.

Without being bound by theory, it is speculated that because the dendritic polymers employed herein have a relatively large macro-structure with large internal voids and a loosely packed core. Hence the dendritic polymers are able to encapsulate the photochromic dye compounds and provide more room to allow freer, or at least reduced hindrance, of the photochromic compounds transitioning between the UV radiated and non-UV-radiated state. It is suspected that this increases the rate of transition both in the forward reaction (i.e. darkening) and in the reverse reaction (fading).

In some of the disclosed embodiments, the dendritic polymers, appropriate modification of the terminal groups, has enhanced their properties (e.g. such as solubility etc.) so that they more readily take up the dendritic polymer. Hence, by proper design and modification, large interior voids in dendrimers may ensure a high switching speed of photochromic dyes while exterior groups of dendrimers may improve its miscibility with coating materials or the lens polymer matrix.

Accordingly, the disclosed encapsulated photochromic dyes may also overcome the challenges encountered when incorporating organic photochromic dyes into plastic materials. This is because the modified terminal end groups of the dendritic polymer are more miscible with the polymer matrix in which they are disposed.

Advantageously, the disclosed encapsulated photochromic dyes may allow direct mixing of the photochromic dyes with a lens monomer, followed by curing of the mixture solution. The fading rate of the photochromic lenses is higher relative to known methods, and is significantly less than ten minutes to switch from a darkened to a colorless state.

Advantageously, the disclosed encapsulated photochromic dyes may be added to hard coating materials without an adverse affect on the fading rate or problems associated with an uneven dispersion of the dyes within the coating layer.

Advantageously, the disclosed encapsulated photochromic dyes may be dissolved in a polymerizable monomer composition and then cured before being casted onto the surface of a substrate, such as a lens. However, because the photochromic dyes are encapsulated by the dendritic polymer, they do not suffer the disadvantage of achieving unsatisfactory adhesion between the lens and the photochromic coating layer. Furthermore, the fading rate is still higher relative to those known in the art.

Advantageously, the disclosed encapsulated photochromic dyes, when in admixture with plastic, may not lose their ability to exhibit a reversible change in color as a result of prolonged repeated exposure to ultraviolet (UV) light.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A photochromic dye encapsulated by a dendritic polymer.

2. A dye as claimed in claim 1, wherein said encapsulated dye is suspended in a substrate.

3. A dye as claimed in claim 2, wherein said dendritic polymer is selected such that it is miscible with said substrate.

4. A dye as claimed in claim 3, wherein the terminal ends of said dendritic polymer are miscible with said substrate.

5. A dye as claimed in claim 2, wherein the inner core of said dendritic polymer is of substantially the same polarity as said photochromic dye.

6. A dye as claimed in claim 1, wherein said dendritic polymer is at least one of a dendrimer and a hyperbranched polymer.

7. A dye as claimed in claim 1, wherein said dendritic polymer is substantially transparent.

8. A dye as claimed in claim 1, wherein said dendritic polymer comprises silicon hydride.

9. A dye as claimed in claim 8, wherein said silicon hydride is silane.

10. A dye as claimed in claim 1, wherein said photochromic dye is hydrophobic.

11. A dye as claimed in claim 1, wherein said dendritic polymer is a dendrimer having a substantially hydrophobic inner core.

12. A dye as claimed in claim 11, wherein the inner core of said dendrimer comprises one or more silicon hydrides or carbosilanes.

13. A dye as claimed in claim 12, wherein the silicon hydride is a silane.

14. A dye as claimed in claim 12, wherein the end groups of said dendrimer are substantially hydrophilic.

15. A dye as claimed in claim 14, wherein the hydrophilic end groups are selected from the group consisting of a hydroxyl group, a carboxyl group, an ether group, a sulfide group, an ester group, an ethoxy group, a phosphoryl group, a phosphinyl group, a sulfonyl group, a sulfinyl group, a sulfonic acid group, a sulfinic acid group, a phosphoric acid group, a phosphorous acid group, an amino group, an amide group, a quaternary ammonium group, and a quaternary phosphonium group.

16. A dye as claimed in claim 1, wherein the photochromic dye is selected from the group consisting of aminotriarylmethanes, benzopyran, chromenes, dihydropyrene, indeno-naphthopyrans, phenanthropyrans, phthalocyanines, Spiro-oxazines, spiropyrans, spirothiopyrans, chromenes, naphthopyrans, oxazines, spiro-naphthoxazines, organo-metal dithiozonates, pyrans, thioindigo, triphenylmethanes, fulgides, fulgimides and combinations thereof.

17. An article comprising a photochromic dye encapsulated by a dendritic polymer.

18. An article as claimed in claim 17, wherein said encapsulated photochromic dye is provided in a coating layer on the surface of said article.

19. An optical lens comprising a photochromic dye encapsulated by a dendritic polymer.

20. An optical lens as claimed in claim 19, wherein said encapsulated photochromic dye is provided in a coating layer disposed on the surface of said lens.

21. An optical lens as claimed in claim 18, wherein said lens comprises a polymer and said encapsulated photochromic dye is provided within said polymer.

22. A method of encapsulating photochromic dye comprising the step of mixing a photochromic dye solution with a dendritic polymer solution.

23. A method as claimed in claim 22, comprising the step of selecting said dendritic polymer to be miscible with the said organic solvent.

24. A method as claimed in claim 23, comprising the step of modifying the terminal ends of said dendritic polymer to be miscible with the solvent of said photochromic dye solution.

25. A method as claimed in claim 22 comprising the step of curing a polymerizable composition comprising said encapsulated photochromic dye.
